(19) United States
(12) Patent Application Publication
(10) Pub. No.: US 2008/0302565 A1
(43) Pub. Date: Dec. 11, 2008

(54) Shielded Connector Comprising an Annular Spring

(76) Inventor: Othmar Gaidosch, Ostfildern (DE)

Correspondence Address: K.F. ROSS P.C., 5683 RIVERDALE AVENUE, SUITE 203 BOX 900, BRONX, NY, 10471-0900, US

(21) Appl. No.: 11/547,438

(22) PCT Filed: Mar. 31, 2005
(86) PCT No.: PCT/EP2005/003362

§ 371 Date: Aug. 14, 2008

(30) Foreign Application Priority Data
Apr. 2, 2004 (DE) 10 2004 016 304.9
Mar. 23, 2005 (DE) 10 2005 013 356.8

(51) Int. Cl. H01R 13/648

(52) U.S. Cl. 174/359

(57) ABSTRACT

The invention relates to a shielded circular connector or a shielded box. The preferably metal housing of said connector comprises at least one cap nut (1) and union screw (2), or two corresponding cap nuts or union screws, which can be fixed by means of a thread, bayonet fitting, detent elements, insert moulding or encapsulation geometry or similar. According to the invention, an annular spring system, consisting of at least one and preferably two annular-segment lamellae (1.1), is situated on the cap nut (1) or union screw (2), said lamellae having a closed sprung ring (1.2) on their ends, interconnecting the latter.

The invention relates to a shielded premanufactured or kit-form single-pole, multipole, or coaxial plug connector according to the features of the preamble of claim 1.

Such shielded plug connectors are known from DE 103 02 170, DE 103 02 711, or DE 103 23 612, for example.

The invention relates specifically to contacts that are stationary relative to one another and preferably rotatable and/or axially displaceable, in particular sliding contacts, that during operation are either always closed or that may also be separated.

It is necessary to produce an appropriate contact force between the contact points, the magnitude of which in turn dictates the size of the resulting metallic and quasimetallic contact areas and therefore the magnitude of the contact resistance.

On the other hand, it is also necessary to actuate such contacts with an appropriate application of force. Limited installation space in particular creates the problem that the frictional force produced by the contact force must not exceed a given level. In addition, as the result of variable large adhesion and sliding friction coefficients and the vibrational characteristics of the particular spring-mass system, particularly for sliding contacts, stick-slip effects arise that must be prevented.

Other aspects that further complicate the solution of such problems are the general effort to increasingly miniaturize components or modules of connectors, minimize the variety of parts and the number of contact points required, make the assembly more efficient, and the like.

In light of these contradictory demands, it is necessary to make such contacts using springs or spring systems that have rigidity over defined directions so that these requirements are met.

There are two known solutions for the problem described above:

1. Two such parts are usually contacted indirectly by use of corresponding press-bent parts, typically using wave washers resilient in the longitudinal axis of the plug or sleeves resilient transverse to the axis.

This first solution has the following disadvantages:

The module has an additional part.

Since relatively filigreed parts are involved, on the one hand there is a handling problem in assembly, and on the other hand such a part may be lost or overlooked during assembly. As a result, the shielding is electrically interrupted. In addition, discovering the absence of such a part during subsequent quality control, if possible at all, entails considerable expenditure of effort.

As a result, the shielding has an additional electrical contact, i.e. an increased volume resistance.

Due to lack of space it is not possible to cover axially resilient washers by an additional side collar in such a way that no openings result in the shielding at the gap between the two metal parts.

2. A further solution consists in designing one of the parts such that it has bendable lamellae, produced from a tubular projection by radial slotting and having cantilevered ends, and these defined undersized ends make resilient contact against a corresponding lateral surface.

This second solution has the following disadvantages:

Bent lamellae produced from a tubular section by radial slotting have the cross-sectional shape of annular segments.

Compared to bent lamellae having a rectangular cross section, for the same thickness and cross-sectional area, such springs have an increased axial moment of area, and therefore for a given spring length and material have a correspondingly higher spring rigidity. This difference is more critical the more pronounced the curvature of such annular segments relative to their width. However, if such lamellae are designed with this in mind so as to be correspondingly narrow in order to achieve a similar rigidity as for comparable rectangular lamellae, a high degree of transverse stability is lost in the direction of rotation or motion. On the one hand, the springs are very susceptible to damage on their cantilevered ends during transport, assembly, and operation, and on the other hand they have a heightened tendency toward the referenced stick-slip behavior.

For certain other spring parameters, annular segment lamellae have a smaller allowable spring travel than rectangular lamellae. Since the adjustment of the spring travel has unavoidable structural associations with a dimensional or tolerance chain, increased demands must be placed on the dimensional accuracy of the corresponding parts.

Contradictory to this demand, however, is the behavior of a closed tubular section that is divided on one side by slotting. Since internal stress points are exposed by this process, it is specifically the ends of the exposed lamellae at which the contact areas are logically located that have the greatest dimensional and shape tolerances.

The object of the invention, therefore, is to provide a shielded plug connector that meets the described demands. Specifically, the invention relates to a shielded circular plug connector or a shielded circular socket (also referred to as a sleeve socket) whose preferably metal housing contains at least one coupling nut and coupling screw or two corresponding coupling nuts or two corresponding coupling screws that perform fastening functions in opposite directions by means of a thread, bayonet fitting, detent element, extrusion coating or encapsulation geometry, and the like. For a given installation space these parts, which are stationary relative to one another and preferably rotatable and/or displaceable, on the one hand must be designed such that in the assembled state they are impermeable to external electromagnetic radiation, i.e. they have no open gaps on the side. On the other hand, as components of the plug or socket shielding, which may be connected to the respective cable shield at another location, they must make a reliable electrical contact with one another. The aim is to avoid the above-mentioned stick-slip phenomena with a reasonable expenditure of effort.

This object is achieved by the features of claim 1.

According to the invention, a ring-spring system composed of at least one, preferably at least two, annular segment lamellae is situated on the coupling nut or on the coupling screw of the plug or sleeve (socket), the lamellae on their ends having a closed spring ring that connects the annular segment lamellae to one another at their ends.

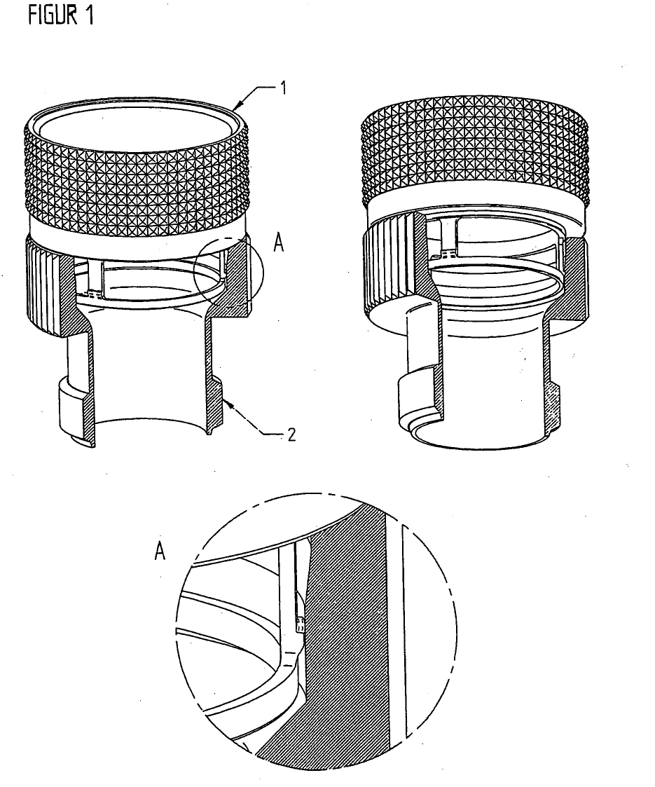

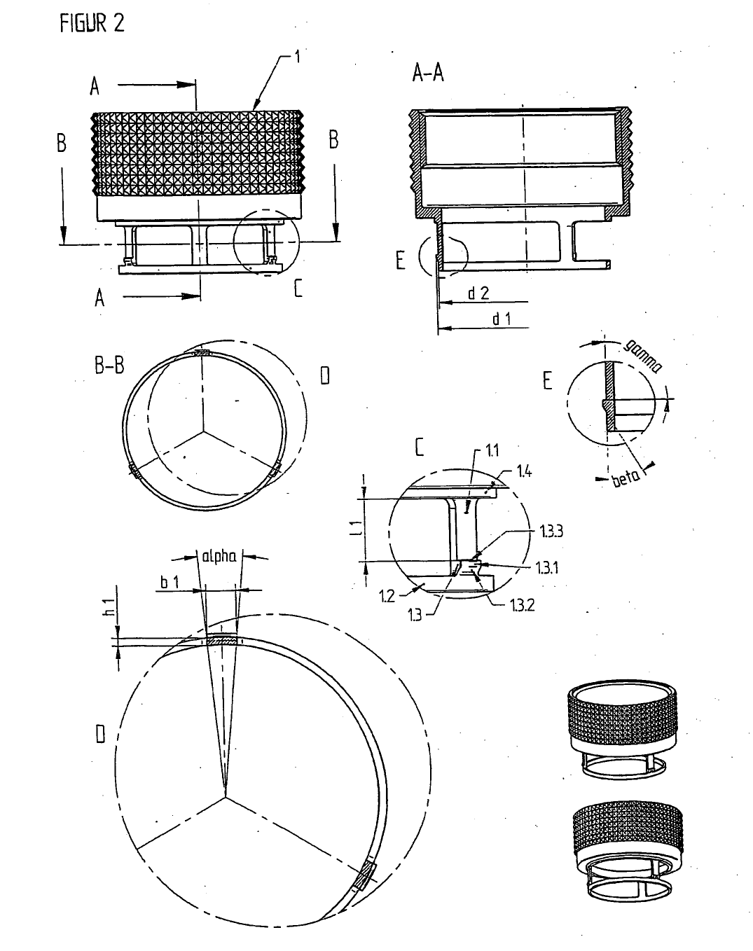

The invention essentially relates to the part illustrated in FIGS. 1 and 2 that is denoted by reference numeral 1. This example involves a coupling nut having a tubular projection that has at least one, preferably at least two, slots preferably produced by milling. Alternatively, these slots may be produced by other manufacturing processes such as polygon lathing (polygon machine tooling) and laser cutting, drilling, pulsing, and etching, and the like. A one-piece spring system is thus formed that is essentially composed of at least one, preferably at least two, preferably symmetrically configured annular segment lamellae 1.1 (which can also be referred to as annular segment bars), and the closed spring ring 1.2 that connects this/these lamella(e) to one another at their resilient ends. Furthermore, it is possible but not necessary for this system to have at least one, preferably at least two, projections 1.3 that have a contact face 1.3.1 and transition surfaces 1.3.2 and 1.3.3. For economical manufacture, these projections preferably should be situated along the annular segment lamellae 1.1 so that no additional machining operation is required. Of course, approaches in which this/these projection(s) is/are provided solely on the spring ring 1.2 or also on the closed spring ring are likewise possible.

With regard to each of these projections, the annular segment lamellae 1.1 converging at this location, or also the partial sections of these annular segment lamellae and the associated spring ring 1.2, form a system of spiral springs connected in parallel, the sum of the rigidities of these sections acting on each of the contact faces 1.3.1.

At the upper end of the annular segment lamellae 1.1 a circumferentially closed collar 1.4 is located that in the assembled state projects into a corresponding recess in the part 2 from FIG. 1, and that due to the axial overlapping ensures a constantly closed shield, taking the resulting tolerance chain into account.

Depending on the particular application, the transition surfaces 1.3.2 and 1.3.3 of the projections 1.3 may have corresponding angles of inclination “beta” or “gamma” with respect to the longitudinal axis, for example to simplify assembly or to allow engagement with a corresponding circumferential groove in the part 2 from FIG. 1, in which case the parts would form a submodule.

With regard to the lateral surfaces of the annular segment lamellae 1.1 resulting from the above-referenced slots, the lamellae may have an axis-parallel orientation over their longitudinal extension, as illustrated for example in FIGS. 1 and 2. However, the lamellae may also have a shape that is oblique, curved, or a combination thereof. Likewise, depending on the shape of the inner and outer lateral surface that delimits them, the annular segment lamellae 1.1 as well as the closed spring ring 1.2 may have a cross section along their respective spring longitudinal axes that is designed to be constant or also continuously or abruptly variable.

Advantages of the Invention:

Compared to the known use of resilient wave washers or resilient sleeves, the approach according to the invention saves an additional individual part. This has the further advantageous results:

Reduction in number of parts,

Reduction in dimensional and tolerance chains,

Reduction in number of contact points,

Simplified assembly,

Avoidance of assembly errors (“overlooking” the wave washer).

The following additional significant advantages result from securely connecting the annular segment lamellae 1.1 to one another at their ends by means of the closed spring ring 1.2:

In this case it is possible (see FIG. 2) to reduce the width “b1,” i.e. the enclosed angle “alpha,” of the annular segments so that they have a moment of area that is approximately comparable to that of a rectangle having the same area and thickness. The greatly reduced transverse stability of the annular segment lamellae 1.1 in the direction of rotation or motion is more than compensated for by the spring ring 1.2. Although the spring ring 1.2 additionally reinforces the entire system, rigidity may be achieved at the contact points between parts 1 and 2 that is noticeably less than if free annular segment springs with sufficient width or transverse stability were used. This advantage becomes increasingly important the smaller the available installation space, specifically, the available space for the spring length “l1”.

If the projections 1.3 are advantageously situated as close as possible to the spring ring 1.2, not only are the allowable spring travels optimized, but the torsional rigidity of the system at the sliding or contact faces 1.3.1 is increased considerably, which in turn significantly reduces the tendency toward the referenced stick-slip behavior.

The thus cross-connected structure of the annular segment lamellae 1.1 and the spring ring 1.2 greatly increases the dimensional or tolerance stability at the contact points 1.3.1, which would be very adversely affected at the free ends of the annular segment lamellae 1.1 as a result of the exposed inner stresses. On the one hand this is advantageous for manufacturing and thus for quality, and on the other hand, with regard to function, significantly more consistent or reproducible contact forces may be established in this manner.

FIG. 2 also shows that the ring-spring system in the region of the annular segment lamellae 1.1 has a main diameter d2, and in the region of the projections 1.3 has a diameter d1. Thus, the thickness of the projections 1.3 is the difference between d1 and d2. Also shown in the lower right section of FIG. 2 is the finished part 1 as a component of the connector (for better clarity, other components or modules of the plug connector are not illustrated), in this case having three annular segment lamellae (it being also possible for fewer or more than three annular segment lamellae to be present). For better handling during the screwing or fastening to a corresponding part this part 1 has a roughened surface, preferably with a rhomboidal or pyramidal shape.

The second part 2 is placed on the ring-spring system of the first part 1 with little application of force, and at this location is fixed in place so as to be rotatably mounted. The situation shown in FIG. 1 is implemented in this manner.

In addition to the described design, further variants are possible that are described below and shown in the additional figures. However, they do not represent a limitation of the invention.

Similarly as for the above-described rotatable sliding contact, it is also possible to implement a purely axially displaceable plug contact or a combination from these variants, which of course, depending on the particular application, would have to be correspondingly designed with regard to the basic dimensions and proportions. Depending on whether the projections 1.3 corresponding to those described above faced outward or optionally inward, plug receptacles or corresponding contact pins or contact sockets contacting inner or outer mandrels would be obtained.

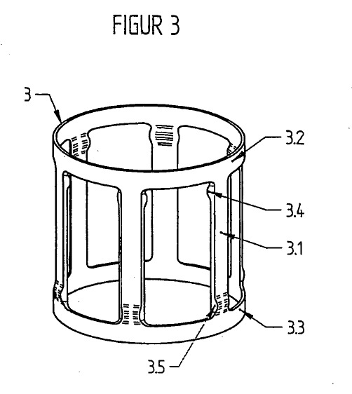

FIG. 3 illustrates a spring cage 3 that operates according to the above-described principle, and that, for example, could be used as an intermediate contact between and an outer and an inner mandrel. The spring cage 3 may also be stationarily, displaceably, and/or rotatably mounted on the coupling nut or the coupling screw. The spring cage 3 has at least one, preferably at least two, preferably symmetrically configured lamellae 3.1 that are connected on each end to closed spring rings 3.2 and 3.3. The lamellae have inwardly and/or outwardly facing projections 3.4 and 3.5, respectively. Of course, the number, location, and orientation of these individual projections along the lamellae 3.1 and/or the spring rings 3.2 and 3.3 may be adapted to the particular application. Compared to the press-bent or press-rolled spring cages in current use, in which the lamellae connections corresponding to the spring rings 3.2 and 3.3 are open at least one location, such a part has a significantly higher dimensional and tolerance quality. In addition, such spring cages are the more economical approach for applications in which corresponding pressing tools are out of the question based on the number of workpieces.

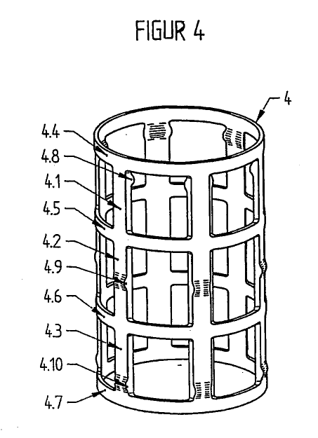

As a further example, FIG. 4 illustrates a multilevel spring cage 4. This spring cage has lamellae 4.1, 4.2, and 4.3 that are connected via closed spring rings 4.4, 4.5, 4.6, and 4.7 and that have inwardly and/or outwardly facing projections 4.8, 4.9, and 4.10. Of course, these projections may be provided also on the spring rings 4.4, 4.5, 4.6, and 4.7. Such a spring cage 4 may be used as a multipoint contact element, the number and location of the lamellae, spring rings, and projections being basically determined depending on the application, and the orientation of the individual projections being opposite that of the respective surface to be contacted.

The second part 2, or the part or module(s) corresponding to part 2, is/are stationarily, rotatably, and/or displaceably mounted with little application of force to the first part 1, to which the spring cage 3 or 4 designed as a ring-spring system is fixedly, stationarily, displaceably, and/or rotatably mounted, and is thus detachably, or preferably nondetachably, connected (plugged in), optionally using further parts not illustrated here.

Shielded plug connectors, i.e. a circular connector or a corresponding circular socket, in which the ring-spring system according to the invention is applicable are known from DE 103 02 710, DE 103 02 711, or DE 103 23 612, for example. For shielding purposes, it is important to establish an electrical contact between the two parts (coupling nut, coupling screw) that are movable relative to one another (rotatable) and the ring-spring system. The reason for shielding the plug connector may also be inferred from this prior art. Alternatively, the present invention is also applicable to plug connectors that have already been manufactured.

### LIST OF REFERENCE NUMERALS

1. Coupling nut
1.1 Annular segment lamellae
1.2 Spring ring
1.3 Projections
1.3.1 Contact points
1.3.2 and 1.3.3 Transition surfaces
1.4 Circumferentially closed collar
2. Coupling nut
3. Spring cage
3.1 Lamellae
3.2 and 3.3 Spring rings
3.4 and 3.5 Projections
4. Spring cage
4.1, 4.2, and 4.3 Lamellae
4.4, 4.5, 4.6, and 4.7 Spring rings
4.8, 4.9, and 4.10 Projections

1. A plug connector designed as a shielded circular connector or a shielded circular socket whose preferably metal housing contains at least one coupling nut (1) and coupling screw (2) or two corresponding coupling nuts or two corresponding coupling screws that perform fastening functions by means of a thread, bayonet fitting, detent element, extrusion coating or encapsulation geometry, and the like, wherein a ring-spring system composed of at least one, preferably at least two, annular segment lamellae (1.1) is situated on the coupling nut (1) or on the coupling screw (2), the lamellae on their ends having a closed spring ring (1.2) that connects the annular segment lamellae (1.1) to one another at their ends.

2. The plug connector according to claim 1 wherein the at least two annular segment lamellae (1.1) are symmetrically configured on the coupling nut (1) or on the coupling screw (2).

3. The plug connector according to claim 2, wherein the annular segment lamellae (1.1) have at least one, preferably at least two, projections (1.3).

4. The plug connector according to claim 1 wherein the closed spring ring (1.2) has at least one, preferably at least two, projections (1.3).

5. Plug connector according to claim 4 wherein the at least two projections (1.3) are symmetrically configured on the spring ring (1.2).

6. The plug connector according to claim 1 wherein the at least one, preferably at least two, projections (1.3) are provided with a contact face (1.3.1) and transition surfaces (1.3.2) and (1.3.3).

7. The plug connector according to claim 1 wherein the projections (1.3) are situated along the annular segment lamellae (1.1).

8. The plug connector according to claim 1 wherein the projections (1.3) are situated close to the spring ring (1.2).

9. The plug connector according to claim 1 wherein the ring-spring system that is detachably or fixedly, stationarily, rotatably, and/or displaceably mounted on the coupling nut (1) or on the coupling screw (2) forms a spring cage (3) having at least one, preferably at least two, lamellae (3.1) that are connected on each end to closed spring rings (3.2) and (3.3).

10. The plug connector according to claim 9 wherein the at least one, preferably at least two, lamellae (3.1) and/or the closed spring rings (3.2) and (3.3) have inwardly and/or outwardly facing projections (3.4) and (3.5), respectively.

11. The plug connector according to claim 9 wherein the spring cage is designed as a multilevel spring cage (4).
